(19) United States
(12) Patent Application Publication
(10) Pub. No.: US 2018/0215434 A1
(43) Pub. Date: Aug. 2, 2018

(54) CENTRAL WHEEL STRUCTURE AUTO-BALANCING DEVICE

(71) Applicant: Shane Chen, Camas, WA (US)

(72) Inventor: Shane Chen, Camas, WA (US)

(21) Appl. No.: 15/884,325

(22) Filed: Jan. 30, 2018

Related U.S. Application Data
(60) Provisional application No. 62/452,346, filed on Jan. 30, 2017.

(51) Int. Cl. B62K 11/00; B62K 3/00

(52) U.S. Cl. CPC B62K 11/007; B62K 1/00; B62K 3/002

(57) ABSTRACT

An ergonomic and rider-friendly auto-balancing personal transportation device. The device may have a central wheel structure with one or more tires and deployable foot platforms located on both sides of the central wheel structure. The platforms may be linked to a handle, such that lifting the handle retracts the foot platforms and releasing the handle may deploy them. The tire size and platform size may be set so that the device is easy to step on to, and the distance to ground when dismounting is reduced. Dual tire and single wider tire embodiments. Embodiments that allow different or multiple rider orientations are also disclosed, as are other features and embodiments.

### CROSS REFERENCE TO RELATED APPLICATIONS

The present application claims the benefit of provisional application No. 62/452,346, filed Jan. 30, 2017, for an Ergonomic, Multiple Orientation Central-Wheel Structure Self-Balancing Device by the inventor herein.

### FIELD OF THE INVENTION

The present invention relates to personal transportation devices and, more specifically, to compact auto-balancing devices that may afford such features as deployable foot platforms, a lightweight ergonomic shape and foot platforms that may be oriented differently with respect to the line of direction of travel, among other features.

### BACKGROUND OF THE INVENTION

The prior art of self-balancing personal transportation devices includes the Segway, described in U.S. Pat. No. 6,302,230 for Personal Mobility Vehicles and Methods, issued to Kamen et al. More recently, the prior art includes the Solowheel, described in U.S. Pat. No. 8,807,250 (the '250 patent) for a Powered Single-Wheeled Self-Balancing Vehicle for Standing Use, issued to Shane Chen, the inventor herein, and which is hereby incorporated by reference as though disclosed in its entirety herein.

The prior art includes self-balancing personal transportation devices. One is the Segway, described in U.S. Pat. No. 6,302,230 for Personal Mobility Vehicles and Methods, issued to Kamen et al., and another is the Solowheel, described in U.S. Pat. No. 8,807,250 for a Powered Single-Wheeled Self-Balancing Vehicle for Standing Use (the '250 patent), issued to Shane Chen, the inventor herein. The '250 patent is hereby incorporated by reference as though disclosed in its entirety herein.

While devices such as those disclosed in the '250 patent are an advancement in the art of transportation devices, they may have disadvantages aspects. One is that they are relatively bulky and heavy, making them somewhat unattractive and difficult to carry or stow, for example, if used in commuting where a person must carrying or stow the device when not in use, i.e., on a bus or train, or in the office. Thus, a need exists for a lighter-weight and/or better form factor device.

Furthermore, larger devices may be more intimidating to a new user, effectively creating a bar to use. A need exists for a lower profile device that is easier to step on or off of and that has a sleeker, less intimidating appearance. A more stable device is also sought.

A need also exists for ready retraction and deployment of foot platforms, including retraction and deployment that occur automatically or near automatically when a user picks up or sets down the device.

In addition, for embodiments having two paired wheels or a single tire structure with two tires, a need exists for pressure equalization between the tires. This would improve shock absorption, steering, turn efficiency, and stability.

Furthermore, a need exists to enhance the riding experience by allowing a rider to stand in different orientations relative to the line of travel of the device. This includes a need for foot platforms that are movable relative to the line of direction and larger platforms that provide multiple standing orientations, among other configurations.

### SUMMARY OF THE INVENTION

Accordingly, it is also an object of the present invention to provide a personal transportation device with ready deployment and retraction of the foot platforms, either through a linkage mechanism or another mechanism.

It is another object of the present invention to provide a personal transportation device that has a “user-friendly” appearance and configuration so that it appears inviting and non-intimidating and is in fact easy to use, particularly for first-time and newer riders.

It is also other object of the present invention to provide a personal transportation device that has a dual tire structure with air pressure equalization and/or a laterally wide tire.

It is yet another object of the present invention to provide a personal transportation device that gives a user options in the orientation of the foot platform(s) relative to the direction of travel of the device.

These and related objects of the present invention are achieved by use of the central wheel structure personal transportation device as described herein.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIGS. 1-6 illustrate one embodiment of a self-balancing personal transportation device in accordance with the present invention.

FIGS. 7-12 illustrate another embodiment of a self-balancing personal transportation device in accordance with the present invention.

FIG. 13 is an elevation view illustrating a wider tire.

FIG. 14 is an elevation view illustrating the potential height of folded platform sections relative to tires.

FIGS. 15-16 are perspective views of yet another embodiment of a self-balancing personal transportation device in accordance with the present invention.

FIG. 17 illustrates the device of FIG. 15-16 yet with a wider tire.

FIGS. 18 and 19 are perspective views of an auto-balancing personal transportation device that affords different riding orientations in accordance with the present invention.

FIGS. 20-22 are perspective views of other embodiments of a central-wheel structure self-balancing personal transportation device that affords different riding orientations in accordance with the present invention.

FIG. 23 is a perspective view that illustrates a supplemental platform that may be mounted onto a central-wheel structure self-balancing personal transportation device to give different rider orientation, in accordance with the present invention.

FIGS. 24A-24D illustrate another embodiment of a central-wheel structure self-balancing personal transportation device in accordance with the present invention.

FIG. 25 is a perspective view of another embodiment of a central wheel structure auto-balancing device in accordance with the present invention, this device offering multi-directional rider orientation.

### DETAILED DESCRIPTION

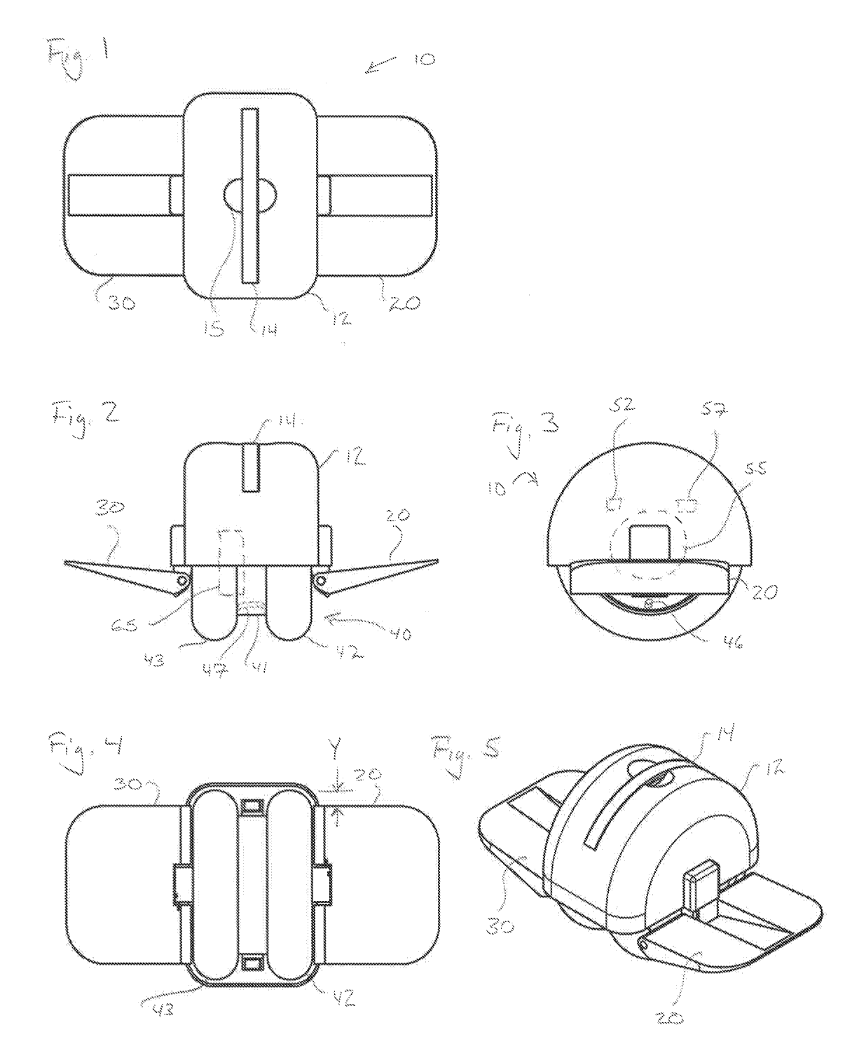

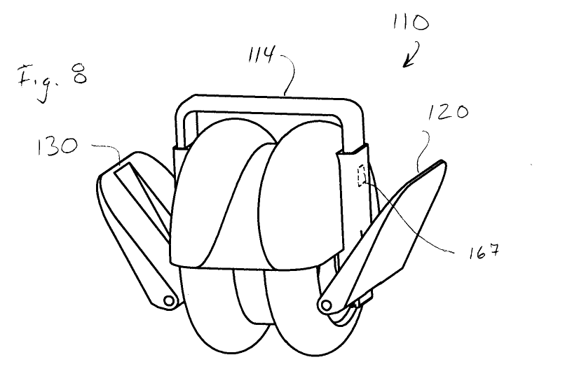

Referring to FIGS. 1-6, one embodiment of a self-balancing personal transportation device 10 in accordance with the present invention is shown. Device 10 operates similar to the self-balancing device(s) of the '250 patent referenced above, particularly with respect to propulsion, speed and direction of travel.

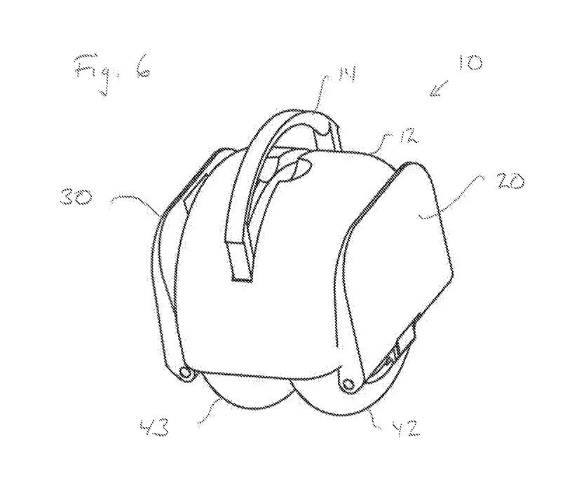

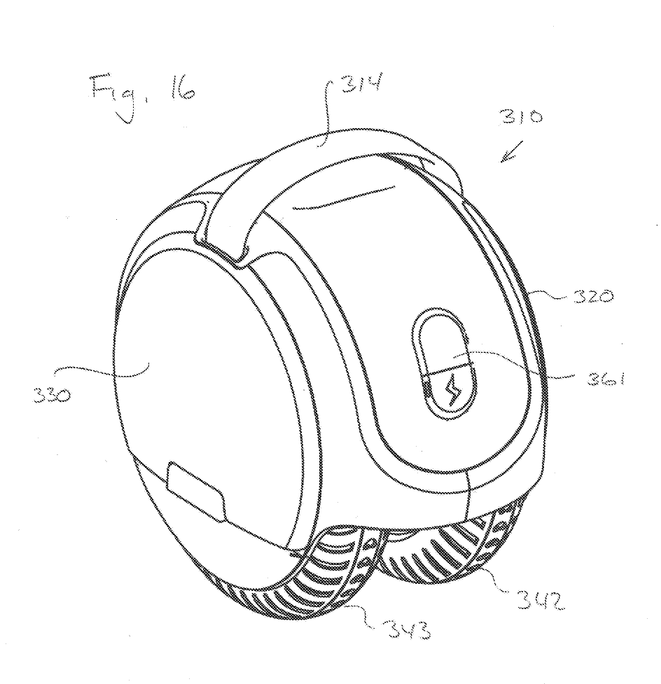

Device 10 may include two tires 42,43 mounted on a rim 41 (FIG. 2). This may be referred to as a “single wheel structure.” In the embodiments of FIGS. 13 and 17 below, a single tire may be provided on a rim, and this may also be referred to as a “single wheel structure.” The term “single wheel structure” as used herein refers to one or more tires mounted to a single rim, or to multiple rims that are coupled together so as to move at the same speed and direction.

As shown in phantom lines in FIG. 3, a gyroscopic position sensor 52, electronic control circuit 57 and a hub motor 55 are preferably provided. The position sensor may sense fore-aft position and the control circuit preferably drives hub motor 55 (which in turn drives rim 41) towards fore-aft balancing of the device based on the sensed fore-aft position. Sensor 52 may also sense side-to-side (or lateral) tilt. Control circuit 57 may adjust speed or other parameters based on a sensed sideways tilt, for example, slowing the device during a turn. Electronic control for a self-balancing single wheel structure vehicle is known in the art.

Device 10 may have two foot platforms 20,30. These are preferably mounted to a frame or housing 12 in such a manner that they may be moved between a deployed or in-use position and a folded or stowed position. In FIGS. 1-5, they are shown in the in-use or deployed position and, in FIG. 6, they are shown in the stowed position.

A transport handle 14 may be provided and, in the embodiment of FIGS. 1-6, may nest within housing 12 when not in use. A finger depression 11 may facilitate extraction of the handle from the nested position.

FIG. 3 illustrates a tire fill valve 46, while FIG. 2 illustrates a conduit 47 through rim 41 that provides air passage between the tires. The tires preferably mount to rim 41 in an air tight manner and air pressure between the tires is equalized through conduit 47. In addition, or alternatively, an exterior conduit may be provided including one that couples to the fill valve of each tire.

The dual tire arrangement increases lateral stability over the devices of the '250 patent (regardless if air pressure is equalized or not).

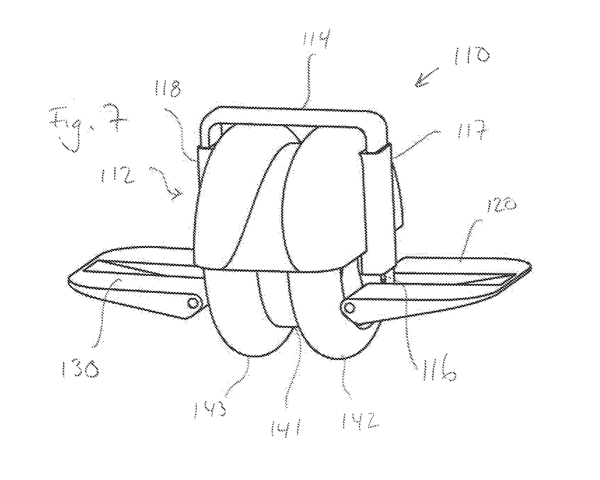

Tires 42,43 are preferably round in lateral cross-section (for example, as shown in FIGS. 2 and 4) as compared to square-cornered tractor-trailer tires. The rounded shape allows a user to turn the device by leaning sideways (decreasing the effective radius).

Turning and stability are further enhanced with pressure equalization. For example, when a user leans laterally, the weight on one tire increases over that of the other. In a device without air pressure equalization, if a riders leans a sufficient amount, then the less weighted tire may lift off the ground. This creates a less stable riding condition than if both tires remain in contact with the ground. A benefit of air pressure equalization is that as weight increases on one tire due to a lean, air is pushed out of that tire toward the less weighted one. This reduces the radius of the more weighted tire and increases the radius of the other tire, resulting in both tires remaining in contact with the ground for a longer time period.

Furthermore, if one tire has a smaller effective radius, then the device will turn towards the side with the smaller radius, thereby increasing the turning ability or effectiveness of the device.

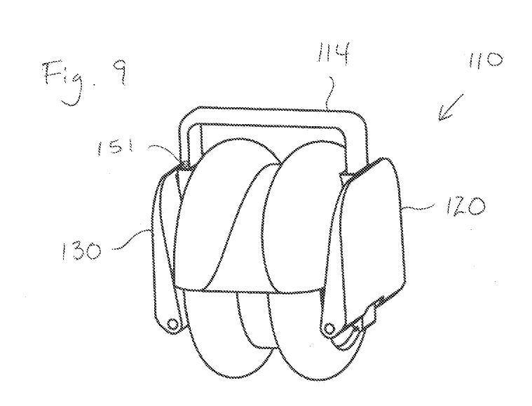

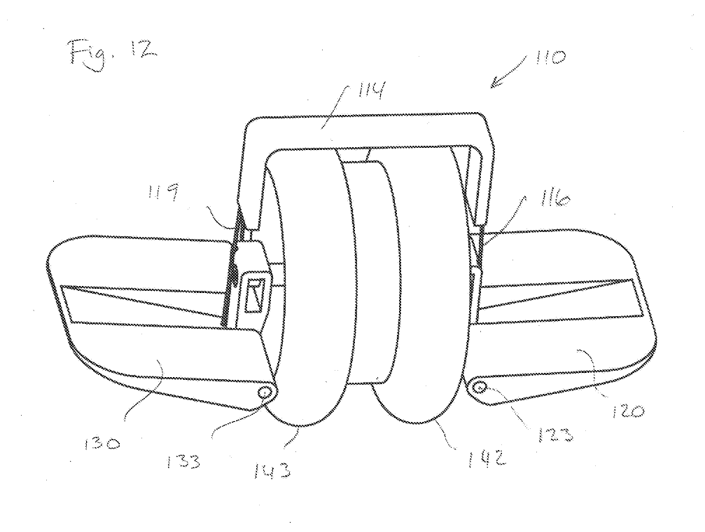

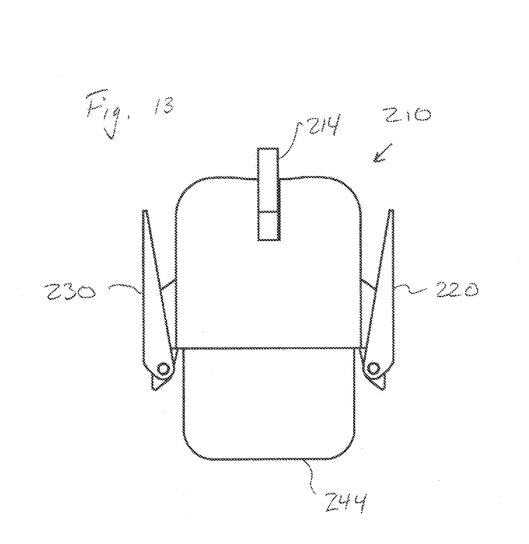

Referring to FIGS. 7-12, another embodiment of a self-balancing personal transportation device 110 in accordance with the present invention is shown. With respect to propulsion and turning, device 110 functions in a similar manner (and has the same or similar components) as device 10 described above. Device 110 has a handle 114 with two ends 113,115. A first cable 116 is coupled between end 113 and foot platform 120 and another cable 119 is coupled between end 115 and foot platform 130 (cable 119 is obscured from view in the perspective of FIG. 7, yet visible in FIG. 12). Ends 113,115 of handle 114 are configured to fit slidably into sheathes 117,118. FIG. 12 illustrates device 110 with the sheathes and housing removed. Cables 116,119 are visible.

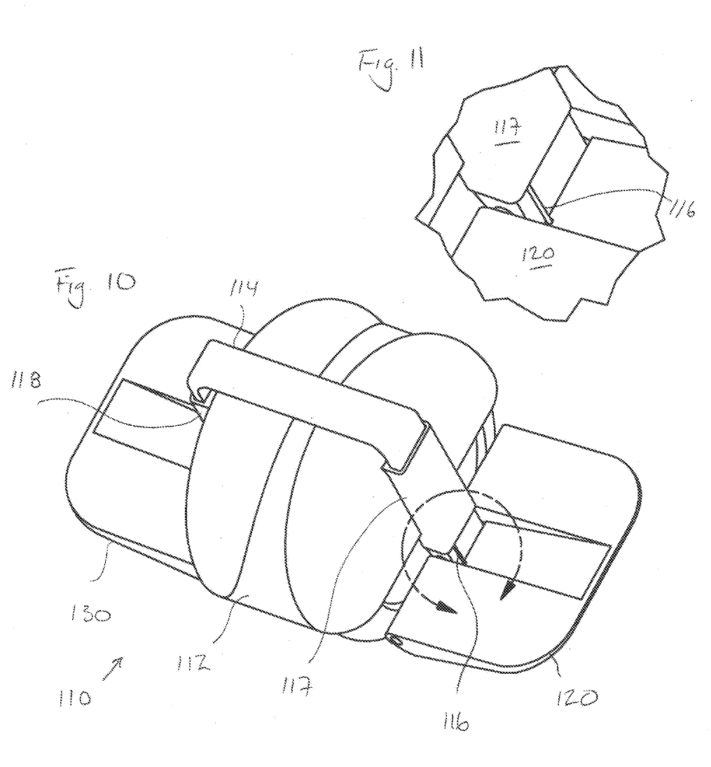

FIGS. 7, 10 and 12 illustrate device 110 with handle 114 fully let down and platforms 120,130 fully deployed. FIG. 9 illustrates handle 14 fully raised and foot platforms 120,130 fully retracted. FIG. 8 illustrates the handle partially raised and the foot platforms partially retracted.

The foot platforms 120,130 are preferably pivotally attached and the cables located an appropriate distance from their pivot axis 123,133 that a relatively short travel distance of the cable yields sufficient movement of each foot platform to move that platform from the extended to the retracted position.

Note that a mechanism such as a releasable latch or magnet or electro-mechanical actuator or hydraulic or other mechanism may be used to latch or lock the platforms in this retracted position. FIG. 8 illustrates a magnet 167 that would attract a piece of magnetic material on foot platform 120. Similar magnetic components could be used for platform 130. If a magnet or latch or cam-based mechanism or the like is provided, then the platforms could be retained in the closed position and handle 114 nested into the housing for very compact stowage configuration, good for stowing under a bus seat or in or under a desk at work or the like.

In addition, handle 114 may be locked or latched in the carry or platforms retracted position. For example, FIG. 9 illustrates a spring biased pin 151 that extends outwardly above sheath 118. This may retain handle 114 in the raised position and thereby hold the foot platforms in the retracted position. A user pushes against the bias force of the pin while pushing down on the handle to “sink” the handle into the sheathes, thereby deploying the platforms.

It should also be recognized that while the tires 142,143 are driven in substantially the same direction and at the same speed (as a single wheel structure), if they were configured as separate wheels, with separate motors (and even separate controls and position sensors), the mechanisms described herein for deploying and retracting the foot platforms would still be applicable (with some tolerance added for the varying positions of the foot platforms, relative to one another, in such a two-wheel device, i.e., a device with independent platform and associated wheel control).

Referring to FIG. 13, yet another embodiment of an self-balancing personal transportation device 210 in accordance with the present invention is shown. Device 210 is similar to device 10 of FIGS. 1-6, yet instead of having two individual tires mounted to a single rim structure, device 210 has only one tire 244, albeit a wide or laterally spread tire. The width of tire 244 provides some of the balance features provided by two parallel tires (42,43) and some of the control provided by tire pressure equalization discussed above. The wide tire 244 may experience more friction with the riding surface then narrow tire(s), resulting in increased drag, faster power consumption, and less ride time between recharge (depending on speed, riding surface, and other variables).

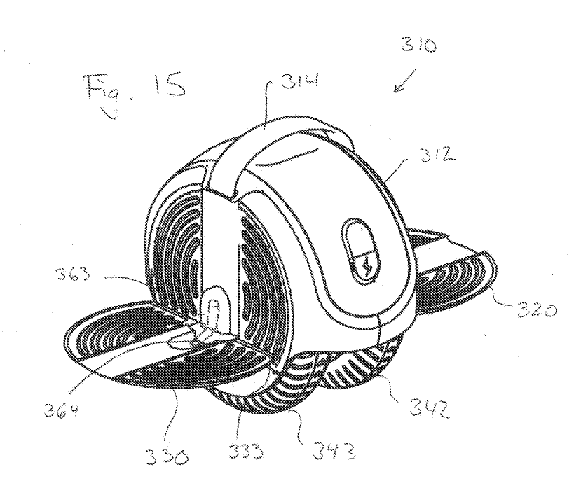

Referring to FIGS. 15-16, perspective views of another embodiment of self-balancing personal transportation device 310 in accordance with the present invention is shown. Device 310 may operate in a manner similar to other transportation devices discussed herein, particularly with respect to propulsion and turning, etc. Device 310 may include foot platforms 320,330, two tires 342,343 (which may be on a single rim or single rim structure), handle 314 and housing 312.

The foot platforms are pivotally coupled, axis 333 for platform 330 is visible in FIG. 15. FIG. 15 illustrates platforms 320,330 in the extended or deployed position while FIG. 16 illustrates them in the retracted or stowage position.

FIG. 15 illustrates electro-mechanical actuators 363 and coupling arm or member 364. Actuator 363 may include a motor that in turn moves arm 364 so that it moves platform 330 between the extended and the retracted position. A similar actuator and arm/member may be provided for platform 320. In addition, other actuator mechanisms may be used, including rotary or axial actuators that are provided about axis 333 (and a similar axis for platform 320) to move the platform between open and closed. Hydraulic (or other) actuators may also be used.

The control circuit may be configured so that a double push or sustained duration push on button 361 initiates the retraction of deployed platforms and vice versa. A magnet or latch or the like 367 may be provided as discussed above for device 110.

FIG. 15 illustrates that the platforms may approximate the shape of the housing 312 or the tires 342,343, at least in part. Above the pivot axis, platform 330 may be curved with an arc that is substantially concentric with an analogous arc of the tires. As shown, the pivot axis of the platforms may be below the axis of rotation of tires 342,343.

FIGS. 15-17 also show that the foot platforms may have an outer edge that is shaped at least in part with a curve, and the maximum distance of the curve from the wheel structure, when the foot platform is deployed, is substantially aligned, when view from above, vertically, with the center of the wheel structure (and the axis of rotation thereof).

Without departing from the present invention, the platforms may have an arc or curve that is not concentric with the axis of rotation of the tires, having, for example, a center that is below or otherwise positioned with respect to the tire axis of rotation, or simply having a different shape, curved or not. Similarly, the platforms may have a principal arc that has a radius that is 0-25% of the radius of the tire, or more preferably between 0-15% or 0-10% or other.

With respect to surface area of the platform relative to the surface area of the vertical plane of a tire (342 or 343), the platform may have a surface area that is 25% of the surface area of the tire. This platform surface area may be 10 to 20 or 25% of the tire vertical plane surface area or be a larger about. The platform may have a surface area from 25-35% of the tire plane surface area or 35-50% or more than 50%, for example from 50% or 60% or more (i.e., 60-70% or 70-80% or other), as discussed below.

For example, if the tire has a radius of 4″ (an 8″ outer diameter), and the arc of the foot platform has a radius 3.5″ (7″ long), then the wheel has a vertical plane area of 50.27 or near 50 sq. in. The area of a 3.5″ circle is 38.48 and half of that is near 20 sq. in. Since the axis 333 is below the rotation axis of the wheel, the platform may have a surface area of approximately 28-32 sq. in., or 30 sq. in. Thus, the platform surface area of 30 sq. in. is 60% of the vertical plane surface area of the tire, 50 sq. in.

If the platform is 6″ long, then the foot platform may have an area approximately 50% of the area of the tire's vertical plane, 25 sq. in. compared to 50 sq. in. If, however, the platform is 6″ long and the tire 10″ in diameter, then the surface area of the foot platform is approximately 30% of the vertical plane area. Further, for a 7″ long platform and a 12″ tire, the platform surface area may be approximately 25% of the vertical plane area of the tire, depending on the configuration of the tire.

FIG. 17 illustrates device 410 that is similar to device 310 of FIGS. 15-16, yet has a single wide tire 444.

Other features of the embodiments of FIGS. 15-17 include that the foot platforms have their greatest width proximate that handle and wheel axle or, in other words, near their center.

In at least one embodiment of the present invention, the tires are smaller than the tire of a standard Solowheel (e.g., a device of the '250 patent).

FIG. 4 shown that the length of the foot platforms is nearly as long as the tire outer diameter, the platform length being 2Y less than the outer diameter of the tire. The length of the foot platforms 20,30 may actually be longer than the diameter of the tire(s), for example, by 1 to 5% or even more, such as form 6-10%, or 11-15% or 16-20% or more.

Conversely, the length of foot platform 20 may be 1-5% less than the diameter of tire 41, or 6-10%, or 11-15% or 16-20% less than the diameter of tire 41, or even a further percentage less of that diameter. In one embodiment, the tires 20,30 may have an outer diameter of 8″ and the platforms are 7″ long (longitudinally, i.e., in the direction of travel of the device).

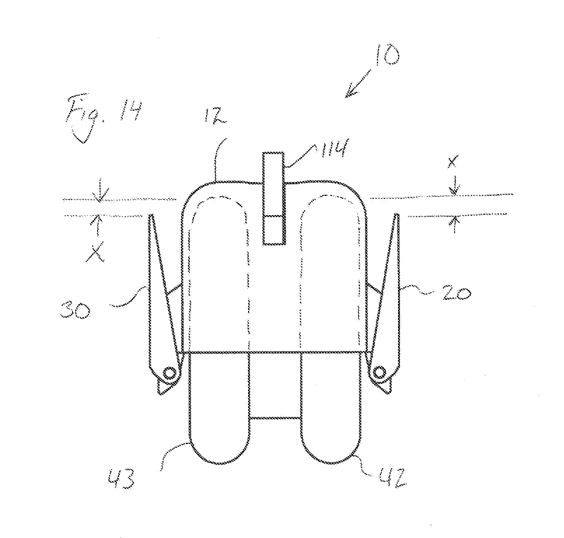

Referring to FIG. 14, it can be seen that the folded platforms nearly reach the same height as their associated tires, X being the difference. It should be noted that the platforms may be taller or shorter than their associated tires by the same range of percentage given above for the length of each platform relative to its tire.

With respect to other components, the battery 65 may be a lithium ion or other suitable battery. Suitable gyroscopic position sensors are known in the art. The device may be made of any suitable materials known for use in self-balancing vehicles.

Multiple and/or Perpendicular Platform Orientations

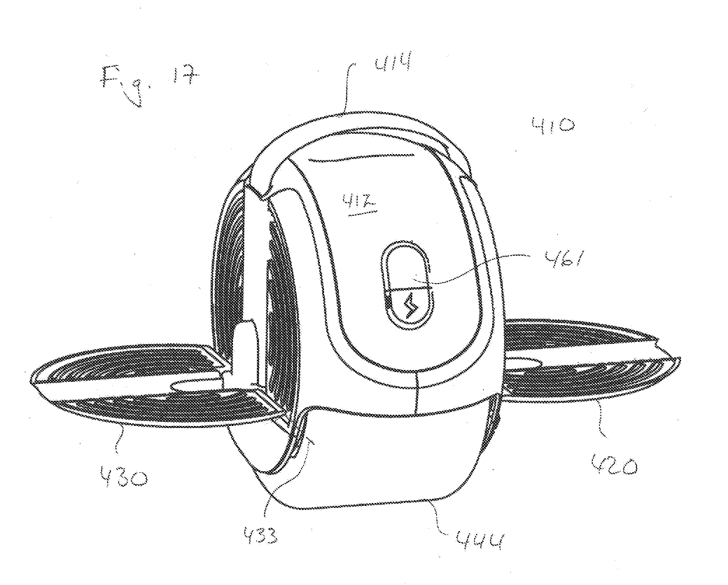

Referring to FIGS. 18 and 19, perspective views of two auto-balancing personal transportation devices 510,610, respectively, illustrating different riding orientations, are shown. It should be recognized that device 510 and device 610 may be the same device, yet in different orientations.

FIG. 18 illustrates that device 510 may have a first and a second foot platform 520,530, respectively, similar to other devices described herein. In FIGS. 18-19, the foot platforms may be provided on the same platform member or “board” 515 that has an opening and fits over wheel structure.

A tire 544 that is preferably wide and substantially laterally stable may be provided between the foot platforms. Tire 544 may be driven by hub motor 555. A gyroscopic or other suitable position sensor 552,553 may be provided with the device to indicate fore-aft lean of the platform.

FIG. 19 illustrates the components of FIG. 18, yet with the platform sections arranged substantially perpendicular to the line of direction of the device. The orientation of FIG. 19 is similar to the orientation of the devices of FIG. 12 discussed above. More specifically, with a wide tire 544, device 610 may resemble device 210 (with platforms deployed) yet without the housing.

Devices 510,610 may, however, include a frame assembly 570 that includes a wheel coupled member 571 (shown in FIG. 19) and a platform coupled member 572 that may be securedly and releasably coupled to one another so that the platform sections may be released and turned 90 degrees from the orientation of the wheel (yet with the electrical connection to sensor 552 preserved via aligned conductors, etc.). Thus, devices 510 and 610 may be either separate devices, or they may be the same device with a frame assembly that supports movement of the platform sections (or platform board 515) relative to the wheel assembly or structure. Suitable releasably securable frame members are known in the art.

Furthermore, while one wide tire is shown in FIGS. 18 and 19, it should be recognized, that two thinner tires may be provided in place of the one wide tire, for example, as two tires are provided in the device of FIG. 11 and one wide tire in the device of FIG. 12. If two tires are provided in devices 510,610, those tires may have a conduit for air pressure equalization and hence be “dual tires.”

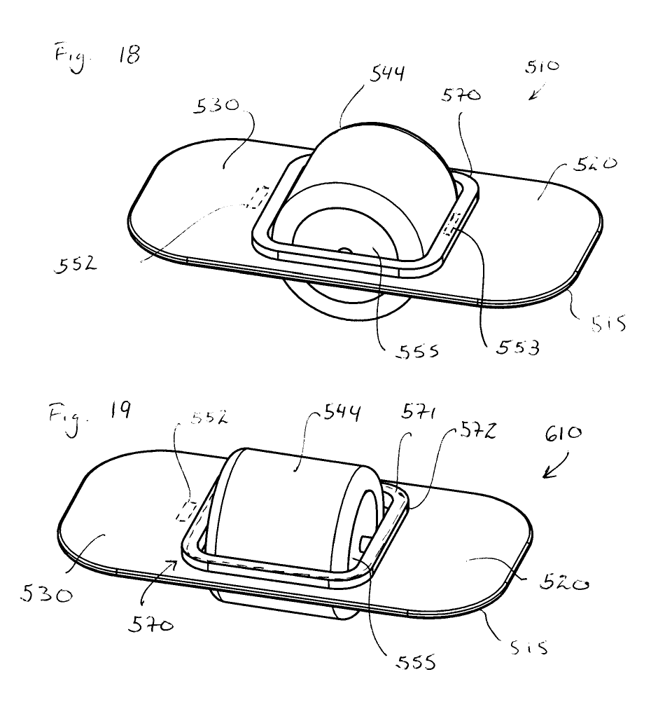

FIGS. 20 and 21 are perspective views of another embodiment of a central-wheel structure self-balancing personal transportation device 710 in accordance with the present invention. Device 710 has similar components to other devices described herein including platform sections 720,730 and wide wheel 744 (that could be two, preferably pressure equalized wheels). Device 710 is similar to devices 510,610 and includes a frame assembly 770 (like assembly 570) that allows the platforms sections to move relative to the wheel arrangement and be re-secured in a position approximately 90 degrees different. In contrast to devices 510,610, device 710 includes a housing 712 and handle 714. Frame assembly 770 (see FIG. 20) preferably includes a coupling member (771) connected to the wheel structure and a coupling member 772 connected to the platforms, with member 771 fitting into and being obscured by coupling member 772.

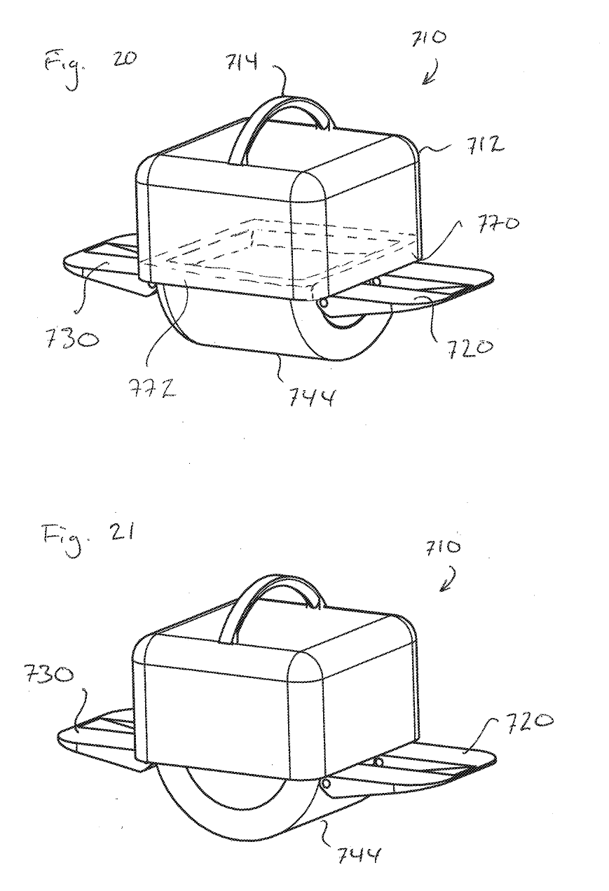

Referring to FIG. 22, yet another embodiment of a central-wheel structure self-balancing personal transportation device 810, in accordance with the present invention is shown. Device 810 is similar to device 710, yet instead of a square or rectangular housing, the housing 812 of device 810 may be more sleek or streamline and include curves. FIG. 22 illustrates that the housing may have a tilted section 811 that is reasonably flat or straight and may be complementary with the flatter top of the platform sections. Other portions 813 of the housing may be more curved.

The platform sections 820,830 may have curved tips 881 that may resemble the curved ends of a snow board or the like. It may be an effective training tool for snowboard riding. The curve of the tips may match the curve of the curved housing portions 813.

Device 810 may include a handle 814 that is more diminutive than that of device 710. The handle may be turnable (and releasably turnable) to give the user options for the position in which they carry the device (to save on arm exhaustion during long carries). The handle may slide into the housing and be flush therewith during use. This may or may not be a telescoping arrangement. As discussed elsewhere herein, there may be one wide tire or multiple parallel tires 842,842, preferably with an air pressure equalizing arrangement.

Though covered by housing 812, device 810 preferably has a frame assembly that allows the housing and platform sections to be released and re-secured to the wheel assembly in a position approximately 90 degrees from that shown in FIG. 22, so that a rider has the option to ride the device standing perpendicular to the line of travel or substantially parallel with (i.e., facing) it.

FIG. 23 illustrates a supplemental platform 925 that may be mounted onto a central-wheel structure self-balancing personal transportation device 910. Device 910 may be similar to devices 10,110 described above or other herein. Like those devices it has two platform sections 920,930, a housing 912, a handle 914 and other related components.

Supplemental platform 925 may have supplemental foot platforms sections 920′,930′. A frame 935 may be provided with the supplemental platform for support and to aid in releasable secure attachment to the original foot platform sections or the housing. For example, four mechanical coupling members 936 may be provided under frame 935 and couple one each to the front and back of each foot platform 9230,930 (only one is shown, in dashed lines). Supplemental platform 925 provides a cost effective manner of allowing device 910 (or 10 or 110), do be ridden parallel with or perpendicular to the line of direction of travel.

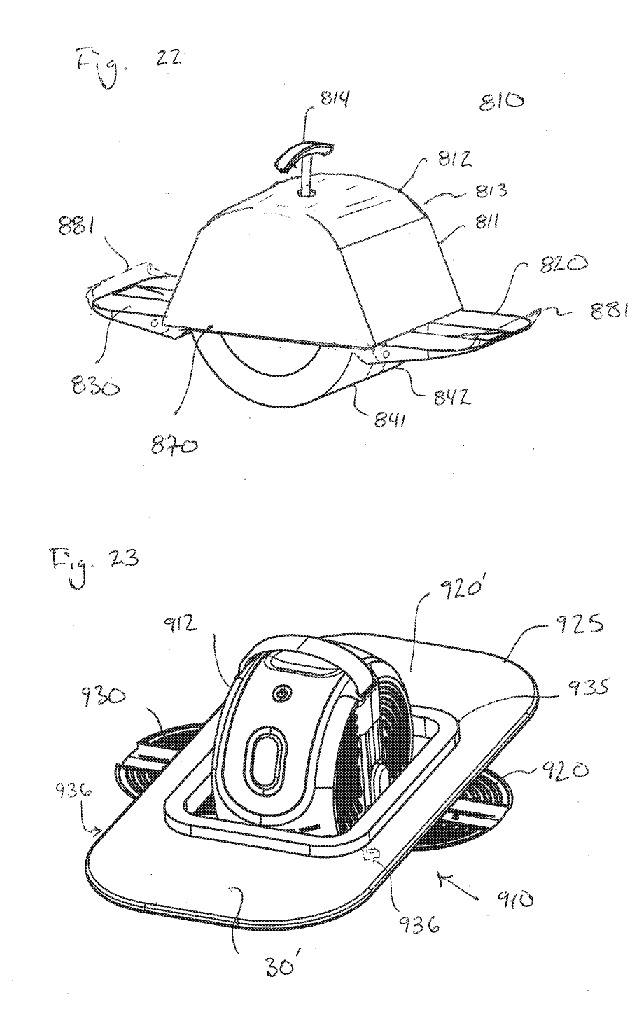

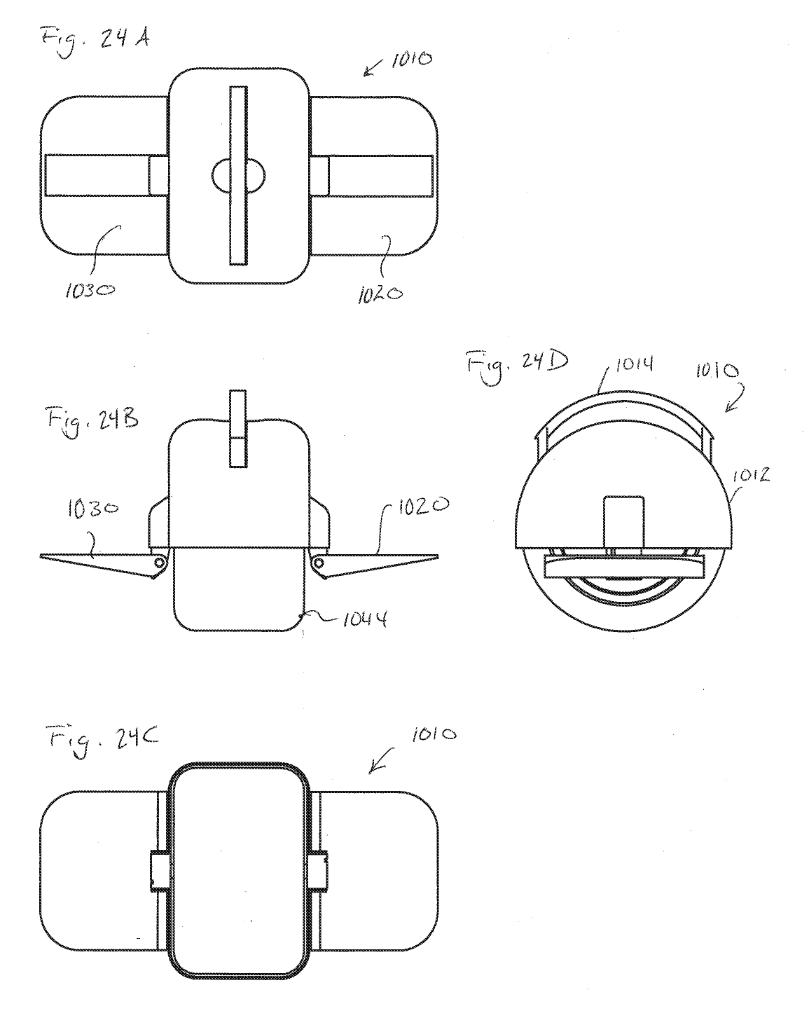

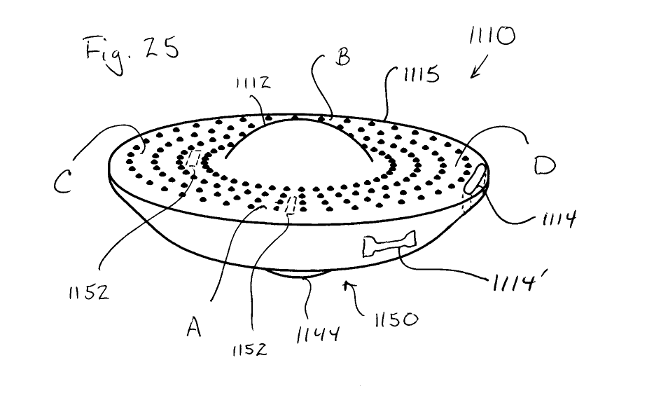

FIGS. 24A-24D illustrate another embodiment of a central-wheel structure self-balancing personal transportation device 1010 in accordance with the present invention. Device 1010 is similar to device 210 of FIG. 12 and other devices. Device 1010 illustrates linkage between the platform sections 1020, 1030 and the handle 1014 in a device having a wide tire 1044. Rods, shafts, levers, or other mechanical components may be provided within housing 1012 and connect the foot platforms to handle 1014 such that further upward movement of handle 1014 begins retraction the foot platforms.

Referring to FIG. 25, another embodiment of a central wheel structure auto-balancing device 1110 in accordance with the present invention is shown. Device 1110 preferably includes an auto-balancing wheel assembly or structure 1150 that includes tire 1144 and is similar, for example, to the wheel structures of FIGS. 18-19 and tire 544 and hub motor 555. In FIG. 25, tire 1144 is positioned for movement generally in a line from left to right or vice versa across the page. A rider standing on locations A and B would be parallel with (facing) that line of travel, while a rider standing at locations C and D would be perpendicular.

Device 1110 may include a broad platform that allows a rider to stand at different orientations without moving or rotating the foot platforms (as discussed above for other embodiments).

A housing 1112 may extend over tire 1144 (as shown), while one or more positions sensors 1152 (preferably gyroscopic sensors) may be provided to detect the pitch of platform 1115.

While a thicker platform shape is shown in FIG. 25, platform 1115 may be thinner and resemble a saucer or planetary ring, like “Saturn.” A handle opening may be provided in or through that ring for easy carry, for example, handle 1114. Alternatively, a handle 1114′ may be mounted to or formed with the support for the platform.

The platform may alternatively be shaped like a flower, having petals, or a honeycomb cell, or a star or other. For example, platform 1115 may have lobes or sub-sections and they may be disposed at 90, 60, 45, 30 degrees or other, from one another.

It should be recognized that in device 510 of FIG. 18 (and others herein) the “position” or gyroscopic sensor is preferably placed on or with the wheel assembly (for example, proximate or under the coupling frame). This is shown with sensor 553. Preferably this is done in the other embodiments with a movable platform. With the sensor coupled to the wheel assembly, the physical position of the sensor does not move when the platform changes orientation. This arrangement may be advantageous in that since the sensor position is not changing there no need to accounting for a new sensor position.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. An auto-balancing transportation device, comprising:
a wheel structure;
a platform including a first foot platform and a second foot platform and, in use, a rider stands with one foot on the first platform and the other foot on the second foot platform; and
a motor, a control circuit and a sensor configured, in part, to drive the wheel structure towards auto-balancing the device based on data from the sensor;
wherein the platform is configured such that the first and second foot platforms can move relative to the live of travel of the device, thereby allowing a rider to change riding orientation; and
wherein the first and second foot platforms are on opposite sides of the wheel structure.

2. The device of claim 1, wherein the platform is configured to allow a rider to stand oriented substantially perpendicular to the line of travel of the device or to stand parallel with the line of travel of the device.

3. The device of claim 1, wherein the platform extends annularly, at least in part, from the wheel structure to form platform surface disposed circumferentially around the wheel structure.

4. The device of claim 1, wherein the platform includes a plurality of at least four sub-sections that are disposed about the wheel structure.

5. The device of claim 1, wherein the platform includes a plurality of sub-sections that are disposed at least one of 90, 60, 45 and 30 degrees from each other around the wheel structure.

6. The device of claim 1, further comprising a handle configured at least one of through the platform, in the platform and on a support for the platform.

7. The device of claim 1, further comprising a housing that covers the wheel structure.

8. The device of claim 1, wherein the platform is movable relative to the wheel structure.

9. The device of claim 8, wherein the platform includes a coupling member and the wheel structure includes a coupling member and the platform and wheel structure coupling members provide releasable secure coupling to one another such that the platform may be released, repositioned to a different orientation and re-coupled.

10. The device of claim 1, wherein the sensor is a position sensor.

11. The device of claim 9, wherein the sensor is a position sensor and is physically associated on the wheel structure such that when the movable platform is re-oriented, the sensor does not move.

12. An auto-balancing transportation device, comprising:
a wheel assembly including a wheel structure and a drive motor;
a platform including a first foot platform that receives one foot of a rider and a second foot platform that receives the other foot of a rider, during use, the first and second foot platforms being located on opposite side of the wheel assembly; and
a control circuit and sensor;
wherein the platform is configured to allow a rider to stand in at least two different riding orientations substantially 90 degrees from one another; and
wherein the motor, control circuit and sensor and configured, at least in part, to drive the wheel structure toward auto-balancing the device.

13. The device of claim 12, wherein the platform is releasably coupleable to the wheel assembly at different rider orientations.

14. The device of claim 13, wherein the sensor is a gyroscopic sensor and is physically coupled to the wheel assembly.

15. The device of claim 12, wherein the platform extends annularly, at least in part, from the wheel assembly to form platform surface disposed circumferentially around the wheel assembly.

16. The device of claim 12, further comprising a handle configured at least one of through the platform, in the platform and on a support for the platform.

17. The device of claim 12, further comprising a housing that covers the wheel assembly and is formed integrally with a surface of the platform.

18. An auto-balancing transportation device, comprising:
a wheel structure;
a first foot platform and a second foot platform, provided on opposite sides of the wheel structure;
a motor, control circuit and sensor configured, in part, such that the motor drives the wheel towards auto-balancing the device based on data from the sensor;
wherein the foot platforms are configured to allow a rider to stand in different orientations relative to the line of travel of the device.

19. The device of claim 18, wherein in the foot platforms are formed upon a larger platform surface that extend in multiple orientations from the wheel structure allowing a rider to stand in different orientations relative to the line of travel of the device.

20. The device of claim 19, further comprising a wheel structure associated coupling mechanism and a foot platform associated coupling mechanism and wherein the wheel structure and foot platform coupling mechanism are releasably, securably coupleable to one another and permit a user to release and re-secure the foot platform relative to the wheel structure to yield at least two different riding orientations relative to the line of travel of the device.
